(19) United States
(12) Patent Application Publication
(10) Pub. No.: US 2005/0076551 A1
(43) Pub. Date: Apr. 14, 2005

(54) Solar illuminated address sign

(76) Inventors: Aaron Silverstone, Toronto (CA); Silviu Iosef-Mihailescu, Richmond Hill (CA)

Correspondence Address: DINSMORE & SHOHL, LLP, 1900 CHEMED CENTER, 255 EAST FIFTH STREET, CINCINNATI, OH, 45202, US

(21) Appl. No.: 10/915,237

(22) Filed: Aug. 10, 2004

Related U.S. Application Data
(60) Provisional application No. 60/493,771, filed on Aug. 11, 2003.

(51) Int. Cl. G09F 13/04

(52) U.S. Cl. 40/568

(57) ABSTRACT

In one embodiment, an illuminated sign is provided for identifying a geographic aspect. The illuminated sign includes a back plate and at least one symbol. The symbol identifies a geographic aspect. A solar panel is supported with respect to the back plate and includes a solar cell, a rechargeable battery, an activation device, at least one LED, and a control circuit. The control circuit is electrically connected with each of the solar cell, the battery, the activation device, and the LED. The control circuit is configured to detect the presence of sunlight and to facilitate selective recharging of the battery with power from the solar cell when sunlight is present. The control circuit is also configured to selectively provide power to the LED from the battery when sunlight is not present so that the LED will illuminate the symbol when sunlight is not present

### RELATED APPLICATION

The present application claims priority of U.S. Provisional Application Ser. No. 60/493,771 filed Aug. 11, 2003 and hereby incorporates the same Provisional Application by reference.

### TECHNICAL FIELD

The present invention relates generally to an illuminated sign. More particularly, in one embodiment, the present invention relates to an illuminated sign and circuitry therefor that involves the use of solar energy to charge rechargeable batteries that are used to selectively illuminate one or more geographic identification symbols or other graphics.

### BACKGROUND OF THE INVENTION

Address signs are commonly used to identify certain geographic aspects such as addresses for geographic locations such as personal residences and business establishments, and have been for years. It can be difficult to locate an address sign at night when there is no illumination. This can be particularly troublesome for emergency personnel, service persons, and delivery persons. For example, ambulance or fire emergency workers can waste valuable life saving seconds or even minutes searching for an address in the dark.

Conventional illuminated address signs can be expensive and difficult to install. In particular, these conventional signs can involve hardwiring a connection with a building's electrical system, which can be time-consuming, messy, troublesome, and expensive to install. Accordingly, there is a need for an illuminated address sign that is inexpensive and simple to install. There is also a need for an address sign and related circuitry that overcomes the shortcomings of dark house numbers and existing illuminated address signs. Improved address sign circuitry is also needed for optimizing performance of illuminated address signs.

### SUMMARY

Accordingly, one aspect of the present invention provides an illuminated address sign that is inexpensive and simple to install. Another aspect of the present invention provides improved address sign circuitry for optimizing the performance of illuminated address signs. Yet another aspect of the present invention provides an address sign that overcomes the shortcomings of dark house numbers and existing illuminated address signs.

To achieve the foregoing and other aspects, and in accordance with the purposes of the present invention defined herein, an illuminated sign for identifying a geographic aspect is provided. In one embodiment, the illuminated sign includes a back plate and at least one symbol configured for association with the back plate. The symbol can identify a geographic aspect. A solar panel is supported with respect to the back plate and includes a solar cell, at least one rechargeable alkaline battery, an activation device, at least one LED, and a control circuit. The control circuit is electrically connected with each of the solar cell, the battery, the activation device, and the LED. The control circuit is configured to detect the presence of sunlight and is further configured to facilitate selective recharging of the battery with power from the solar cell when sunlight is present. The control circuit is also configured to selectively provide power to the LED from the battery when sunlight is not present so that the LED will illuminate the symbol when sunlight is not present.

In accordance with another exemplary embodiment of the present invention, an illuminated sign for identifying a street address of a geographic location is provided. The illuminated sign includes a back plate having a plurality of apertures. Each aperture is configured to receive a screw for mounting the back plate to a wall. At least one reflective number is configured for association with the back plate through use of an adhesive whereby the number identifies a street address corresponding to a geographic location. A solar panel is attached to the back plate and includes a solar cell, at least one rechargeable alkaline battery, an activation device, at least one LED, and a control circuit. The activation device comprises at least one of a jumper and a switch. The control circuit is electrically connected with each of the solar cell, the battery, the activation device, and the LED. The control circuit is configured to detect the presence of sunlight by monitoring voltage generated by the solar cell. The control circuit is further configured to facilitate selective recharging of the battery with power from the solar cell when sunlight is present. The control circuit is also configured to selectively provide power to the LED from the battery when sunlight is not present so that the LED will illuminate the number when sunlight is not present.

In accordance with yet another exemplary embodiment of the present invention, an illuminated sign for identifying a street address of a geographic location is provided. The illuminated sign includes a back plate having a plurality of apertures. Each aperture is configured to receive a screw for mounting the back plate to a wall. At least one number is configured for association with the back plate. The number identifies a street address corresponding to a geographic location. A solar panel is attached to the back plate and includes a solar cell, at least one rechargeable battery, an activation device, at least one LED, and a control circuit. The control circuit is electrically connected with each of the solar cell, the battery, the activation device, and the LED. The control circuit includes a switch having a low voltage drop across its switched terminals as compared to the voltage drop across a standard blocking diode. The switch is configured to selectively facilitate current flow from the solar cell to said battery. The switch is further configured to interrupt the current flow when the voltage of said battery exceeds the voltage produced by the solar cell. The control circuit is configured to detect the presence of sunlight by monitoring voltage generated by the solar cell and is configured to facilitate selective recharging of the battery with power from the solar cell when sunlight is present. The control circuit is also configured to selectively provide power to the LED from the battery when sunlight is not present so that the LED will illuminate the number when sunlight is not present.

The present invention as described herein is advantageous for providing an illuminated address sign that is inexpensive and simple to install. The present invention is also advantageous for providing improved address sign circuitry for optimizing performance of illuminated address signs. Furthermore, the present invention is advantageous for providing an address sign that overcomes the shortcomings of dark house numbers and existing illuminated address signs. Additional aspects, advantages, and novel features of the invention will be set forth in part in the description that follows, and in part will become apparent to those skilled in the art upon examination of the following or may be learned with the practice of the invention. The aspects and advantages of the invention may be realized and attained by means of the instrumentalities and combinations particularly pointed out in the appended claims.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a front perspective view depicting an assembled illuminated sign in accordance with one exemplary embodiment of the present invention;

FIG. 2 is an exploded front perspective view depicting the illuminated sign of FIG. 1 when partially disassembled;

FIG. 3 is a bottom rear perspective view of the solar panel of the illuminated sign of FIGS. 1-2; and

FIG. 4 is a schematic diagram depicting an exemplary electronic circuit for the illuminated sign of FIGS. 1-3.

### DETAILED DESCRIPTION OF THE ILLUSTRATED EMBODIMENTS

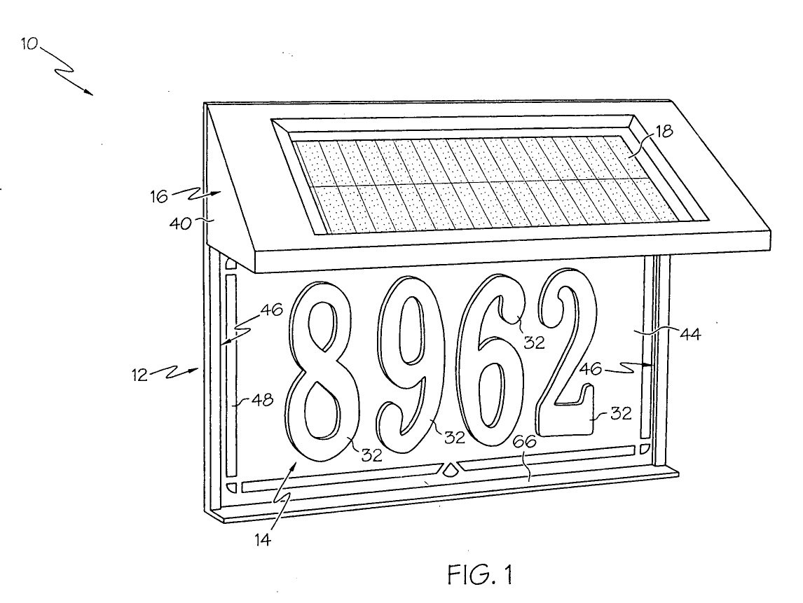

The present invention provides a new illuminated sign, allowing anyone, particularly emergency crew and personnel, to effectively locate an address at night. The sign can be totally powered by solar energy and accordingly does not require the services of an electrician, and can instead be easily installed by the user. Exemplary embodiments of the present invention and its operation are hereinafter described in detail in connection with the views and examples of FIGS. 1-4, wherein like numbers indicate the same or corresponding elements throughout the views.

An exemplary illuminated sign 10 of the present invention is shown in FIGS. 1-3 to include a back plate 12, a solar panel 16, and one or more symbols 14 for identifying a geographic aspect or location. In one typical embodiment, such a symbol 14 comprises one or more numbers 32 (e.g., numbers “8962”) as are typically used to identify a street address corresponding to a geographic location such as a house or building. The symbol(s) or indicia 14 can be formed from any of a variety of materials, although in one embodiment, the symbol(s) 14 may be formed from a reflective white plastic material (e.g., white plastic polyethylene).

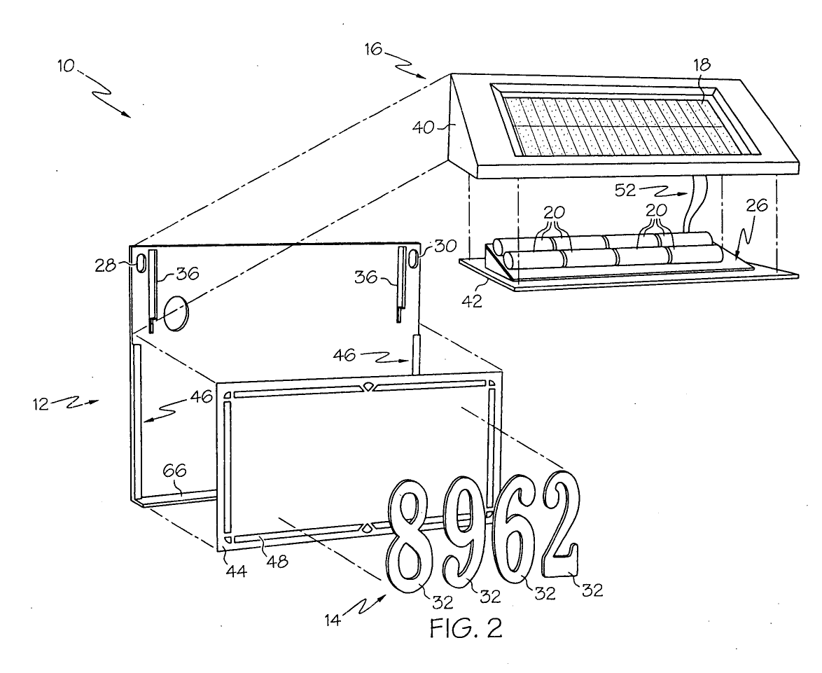

The symbol(s) 14 can be associated with the back plate 12 in any of a variety of specific manners. For example, as shown in FIGS. 1-2, the symbols 12 (e.g., numbers 32) can be associated with the back plate 12 through use of an adhesive. In particular, the numbers 32 can be attached to an intermediate plate 44 with an adhesive, and the intermediate plate 44 can then be mechanically connected to the back plate 12 (e.g., through a sliding engagement of the intermediate plate 44 into grooves 46 of the back plate 12). Alternatively, the symbol(s) 14 might instead be directly associated with the back plate 12 through their attachment to the back plate 12 with an adhesive, thus avoiding the need for any intermediate plate 44. The back plate 12 can thereby serve as a background for the symbol(s) 14. One advantage of having the intermediate plate 44, however, is that the symbol(s) 14 can be more easily replaced if ever required (e.g., the intermediate plate 44 having the old symbols can be discarded, while the new symbols can be attached to a new intermediate plate 44 or directly to the back plate 12). It should be appreciated, however, that symbol(s) might be associated with the back plate 12 and/or the intermediate plate 44 in some other manner not involving adhesives. A template might be provided to assist a user in effectively aligning the symbol(s) with respect to the back plate 12 and/or the intermediate plate 44. A reflective border 48 may be provided to surround all of the symbol(s), as shown for example in FIG. 1. Although the border 48 may merely be decorative, the border 48 might additionally provide visual confirmation to an onlooker that he or she can see the entirety of the symbol(s) 14 on a particular sign 10.

The back plate 12 can be configured to be secured with respect to a stationary structure. For example, the back plate 12 can include a plurality of apertures (e.g., 28 and 30 shown in FIG. 2) that are each configured to receive a screw for mounting the back plate 12 to an exterior wall of a house or building. As another alternative, the back plate 12 might be configured to connect with a ground stake or a road-side mailbox.

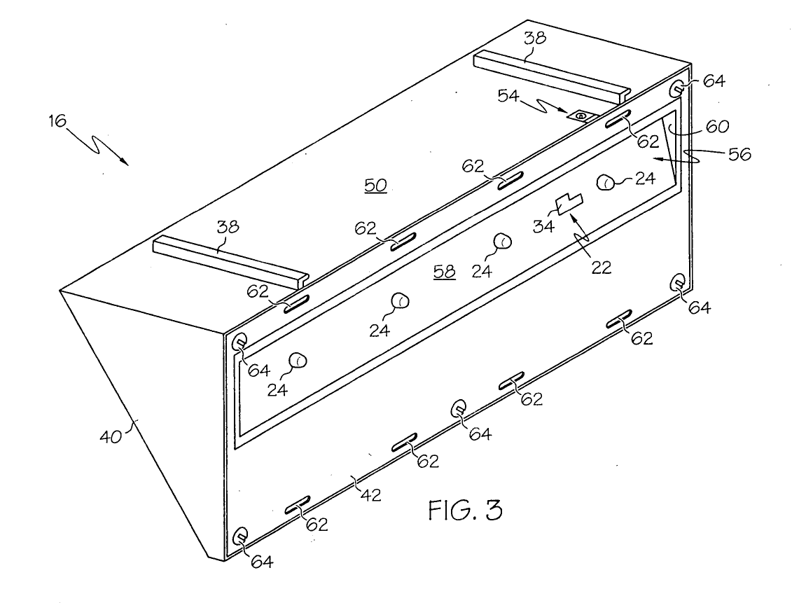

The solar panel 16 can be supported by the back plate 12 in any of a variety of specific configurations. In one exemplary embodiment, as shown for example in FIGS. 2-3, the solar panel 16 and the back plate 12 each comprise interconnecting fastener arrangements 36 and 38, and these fastener arrangements 36, 38 can facilitate selective attachment of the solar panel 16 to the back plate 12. In this particular example, the fastener arrangements 36, 38 facilitate sliding engagement of the solar panel 16 onto the back plate 12, such that the solar panel 16 is supported by the back plate 12, which in turn is supported by a wall, a stake, or a mailbox, for example, as discussed above. It should be appreciated that the solar panel 16 might alternatively be attached to the back plate 12 in any of a variety of other manners (e.g., with fasteners, adhesives, or other such devices).

The solar panel 16 can comprise a top member 40 and a bottom member 42 which cooperate to form an enclosure. This enclosure can be adapted to support a solar cell 18 (e.g., multi-crystalline 8.4V/200 mA), a control circuit (e.g., at least partially inhabiting circuit board 26), one or more rechargeable batteries 20 (e.g., eight AA 1.5V rechargeable alkaline marketed under the trademark GRANDCELL), one or more LEDs 24 (e.g., having a wide viewing angle), and any of a variety of other electrical components associated with an exemplary illuminated sign. As shown in FIG. 3, the top member 40 of the solar panel can have a rear surface 50 that can selectively interface the back plate 12. The top member 40 can support a solar cell 18 at an inclined angle with respect to the back plate 12 when the solar panel 16 is attached to the back plate 12 and the back plate 12 is vertically oriented (e.g., as in FIG. 1). The top member 40 is designed to hold the solar cell 18 at angle that allows maximum light gathering. This angle also allows the rain and snow to slide off and not stick and build up on the solar cell 18. Because of this angle, rain, snow and other debris can simply roll off of the solar panel 16, and can thereby avoid causing any obstruction to the receipt of sunlight by the solar cell 18.

The bottom member 42 can be selectively removable from the top member 40, as shown for example in FIG. 3, in order that a user may access the electrical components within the solar panel 16 (e.g., to change the batteries 20). When the solar panel 16 is assembled with the back plate 12 (as in FIG. 1), the bottom member 42 can extend outwardly from and above the symbol(s) 32 so as to provide an overhanging structure, and can support one or more LEDs 24 (as shown best in FIG. 3). When the illuminated sign 10 is fully assembled, the LEDs 24 can be angled so that their emitted light can effectively illuminate the symbol(s) 14 associated with the back plate 12. For example, the bottom member 42 can support the circuit board 26 at twenty-seven degrees below horizontal so that the reflection of the LEDs 24 connected to the circuit board 26 can be maximized. In addition to supporting the LEDs 24, the bottom member 42 can also support the batteries 20 and at least part of the control circuit. As shown in FIG. 2, the control circuit, the batteries, and the LEDs can all be connected to a circuit board 26 that is attached to the bottom member 42 of the solar panel 16. The solar cell 18 can connect to the circuit board 26 with wires 52. As shown in FIGS. 1-3, the LEDs 24 can reside within a recess 56 within the bottom member 42. This recess 56 can provide reflective surfaces (e.g., 58 and 60) to help effectively direct light from the LEDs 24 to the symbol(s) 14. The bottom member 42 might also include vent apertures (e.g., 62) for allowing the escape of any heat generated by the components within the solar panel 16. One or more screws (e.g., 64) can be provided to selectively secure the top member 40 with the bottom member 42. The back plate 12 can also include a ledge 66 that can assist in reflecting light from the LEDs 24 toward the symbol(s) 14 (while also serving to prevent the intermediate plate 44, when present, from sliding out of grooves 46).

The back plate 12 and the solar panel 16 can be formed from any of a variety of materials and using any of a variety of manufacturing techniques. As one particular example, both the back plate 12 and solar panel 16 can be formed through injection molding, and can be made of black ABS UV plastic. It should be appreciated, however, that the back plate 12 and solar panel 16 need not be formed from similar materials and/or through similar processes.

Prior to use, an exemplary illuminated sign 10 might be kept in “storage mode.” While in storage mode, the electronics within the solar panel 16 are deactivated such that the leakage current drawn from the batteries 20 is negligible so that battery storage life is not affected. Accordingly, an illuminated sign 10 can be provided from the factory with new rechargeable alkaline batteries 20, and those batteries 20 can remain nearly fully charged until a user wishes to actually use the illuminated sign 10. An activation device 22 may be provided to enable a user to select normal operation instead of storage mode. This activation device 22 can, for example, comprise a jumper that can be pulled by a user, or alternatively, a switch (e.g., a sliding switch 34) that can be toggled by a user. When the activation device 22 is so engaged by a user, the illuminated sign 10 can begin operation. As depicted in FIG. 3, this activation device 22 can be associated with the bottom member 42 of the solar panel 16 and can be located proximally to the LEDs 24. This placement can protect the activation device 22 from environmental damage, and can help to obscure it from observation by onlookers.

During normal operation of the illuminated sign 10, the solar cell 18 gathers solar energy during the day and converts this solar energy to electrical power. The control circuit then passes this electrical energy to one or more rechargeable alkaline batteries 20 which are thereby charged. The control circuit then detects when sunshine subsides, such as, for example, by monitoring voltage generated by the solar cell 18 (e.g., the control circuit knows that sunshine has subsided by sensing decreased voltage produced by the solar cell 18). The control circuit then draws power from the rechargeable alkaline batteries 20 and supplies this power to one or more LEDs 24. These LEDs provide illumination upon the symbol(s) 14 (e.g., the address numbers 32), and the symbol(s) 14 can be configured to reflect light generated by the LEDs 24. When sunlight is restored, the control circuit ceases applying battery power to the LEDs, and resumes charging of the batteries 20 with power from the solar cell 18. In this manner, the solar cell 18 assists the control circuit in automatically turning on and off the LEDs 24 as needed to ensure around-the-clock visibility of the symbol(s) 14. The illuminated sign 10 thereby automatically turns on at dusk and off at sunrise, ensuring illumination when no one is available to manually activate the LEDs 24.

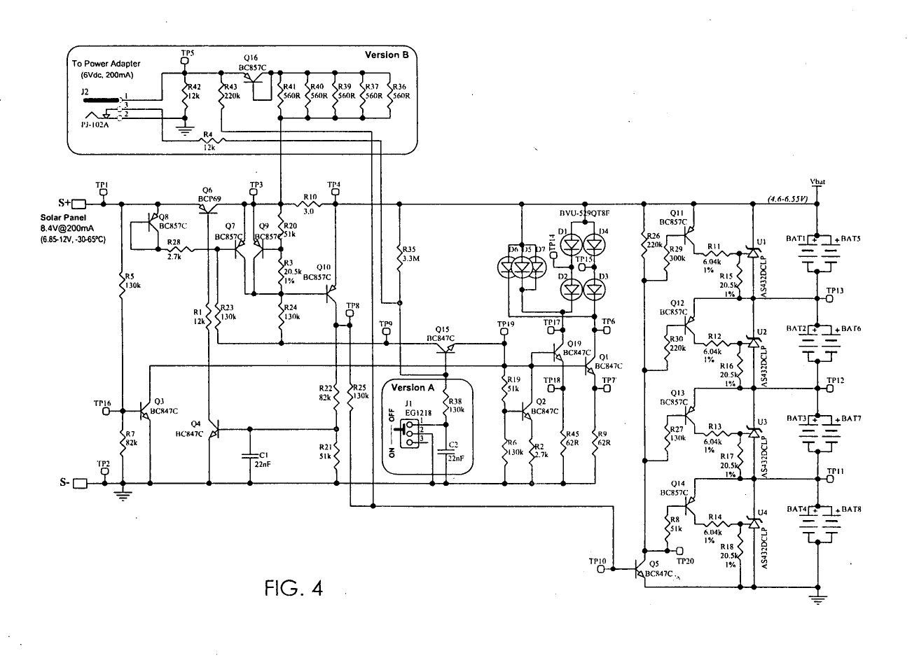

For the illuminated sign 10 to work well over a period of time, the control circuit should be designed so that the power consumed by the LEDs 24 at night can be regenerated during the next day. In one embodiment of the present invention, four red LEDs (e.g., 24) can be employed to illuminate the symbol(s) 14 at night, while in another embodiment, three white LEDs (not shown in FIG. 2, but depicted in FIG. 4 as D5, D6 and D7 and discussed below) can alternatively be employed to illuminate the symbol(s) 14 at night. Other colors and/or quantities of LEDs might alternatively be provided for illuminating the symbol(s) at night, provided, however, that their combined power consumption is not excessive. The LEDs can be selected to consume only a minimal amount of power for maximum economy.

For example, if the combined LEDs 24 only draw 8 mA at a selected operational voltage from the rechargeable alkaline batteries 20 over an exceptionally long night (e.g., twelve hours), then only 96 mAh would be expended from the rechargeable alkaline batteries 20. Accordingly, the solar cell 18 needs only to replenish 96 mAh into the rechargeable alkaline batteries 20, which should be achievable relatively quickly during the next day. For example, in a typical case, when eight 1.5V/1500 mAh AA batteries are provided in four series of dual-parallel cells, then a total capacity of 3000 mAH at 6V can be available from the batteries 20 (e.g., as shown in FIG. 4). Consuming only 96 mAh from this 3000 mAh source accordingly presents very little load, and should therefore enable the useful lives of the rechargeable alkaline batteries 20 to be maximized. Fully charged batteries (e.g., new batteries) can accordingly provide weeks of operation without any charging. During normal operation of the exemplary illuminated sign 10, no external power is required, and the illuminated sign 10 is self-contained and maintenance free.

Rechargeable alkaline batteries have significant advantages for this application as compared to other rechargeable battery types. For example, the rechargeable alkaline batteries are stable in extreme weather conditions (cold or heat), have relatively large storage capacities, and if little current is drawn from them, they can be recharged numerous times (over one-thousand times). As previously indicated, only small amounts of energy (e.g., less than 5% of a battery's total charge) could be drawn from such batteries during a normal operational cycle of the illuminated sign 10. Hence, rechargeable alkaline batteries are well suited for use within the illuminated sign 10, and can achieve long service periods. Other rechargeable battery types might alternatively be employed in some alternate embodiments.

An optional on-board power jack 54 can be provided in association with the solar panel 16. For example, this jack 54 can be present on the rear surface 50 of the solar panel 16, as shown in FIG. 3, for example. The jack 54 can be electrically connected with the control circuit and can be configured for selective connection to an external wall plug power adapter. Accordingly, through the jack 54, an external wall plug adapter (e.g., 6 Vdc/200 mA with 2.1 mm plug) can provide power to the control circuit. The control circuit can be configured such that this power can be used to operate the LEDs 24, to assist the solar cell 18 in recharging the batteries 20, or to recharge the batteries 20 without help from the solar cell 18. However, when the wall plug adapter is so provided, it should be appreciated that the illuminated sign 10 could function even if the batteries 20 were removed or were no longer chargeable. When the batteries 20 ultimately reach the end of their useful lives, they can either be replaced by a user (by removing the lower part of the solar panel), or the external power adapter may then be employed as discussed above. In one alternate exemplary mode of operation, the illuminated sign 10 can receive power from the external power adapter, but can provide continuous illumination from the LEDs 24 upon the symbol(s) 14, both day and night. This mode might be selectable by means of a switch or a jumper (e.g., 34), or might otherwise be automatically selected upon connection of the power adapter with the jack 54.

An exemplary electronic circuit for the illuminated sign 10 of FIGS. 1-3 is depicted in FIG. 4, and this circuit can be configured according to additional aspects of the invention. It should therefore be appreciated that any of a variety of alternate circuit configurations might be employed to achieve the illuminated sign 10 as disclosed and claimed herein. The components and functionality of the exemplary circuit of FIG. 4 will be appreciated by those skilled in the art, although brief reference will hereafter be provided to certain functional aspects/components thereof. First, this exemplary circuit includes solar panel interface components. These components monitor the voltage provided by the solar cell, and detect the dark threshold (Q3) and charge threshold (Q7, Q8). These components also include a reverse power blocking and control switch (Q6), as well as a current limit control circuit (Q9, Q10) that limits the current supplied by the solar cell (e.g., to 75 mA±15 mA) to the batteries.

In some solar cell applications, a blocking diode may be provided to prevent leakage currents from escaping from the batteries into the solar cell (e.g., such as can otherwise occur when the solar cell is not charging the batteries). However, no such blocking diode is provided in the circuit of FIG. 4. Instead, the circuit of FIG. 4 includes a transistor switch (Q6) that operates to perform the function of preventing leakage current, except that the switch (Q6) only absorbs a fraction of the voltage drop (across its collector-emitter junction) than would otherwise be absorbed by a similarly situated blocking diode. Hence, the switch (e.g., transistor Q6) can have a low voltage drop (e.g., less than 0.1V) across its switched terminals (e.g., the emitter and collector of Q6) as compared to the voltage drop across a standard blocking diode (e.g., 0.7V). As the solar cell must produce enough voltage above this voltage drop to charge the batteries, it has been found that a lower-voltage solar cell can thus be provided when a transistor switch (Q6) is used in lieu of a blocking diode (as in FIG. 4).

The switch (Q6) of FIG. 4 is also shown to be configured to selectively facilitate current flow from the solar cell to the battery. More particularly, the switch (Q6) can be configured to substantially completely interrupt the current flow between the solar cell and the batteries when the voltage of the batteries exceeds the voltage produced by the solar cell (as described above to prevent leakage currents). Also, the switch (Q6) can be used to modulate or otherwise variably adjust the amount of power that is allowed to pass to the batteries. In this manner, the switch (Q6) can limit the amount of current that is passed from the solar cell to the batteries (and to the shunt regulators, as described below).

Other components are provided to drive the LEDs. For example, certain of these components provide LED current control and temperature compensation (e.g., transistors Q1, Q2, Q19). This exemplary circuit also includes power adapter interface components that detect when power is present (e.g., resistor R43) so that shunt protection can be provided for the batteries. Also, this circuit provides components (e.g., resistor R4) to detect a missing plug (indicative of storage mode) and to disable biasing (e.g., transistor Q15), thereby deactivating all circuits. This circuit also includes a resistor network for providing a current limiting function (R36, R37, R39, R40, R41).

Other components within this exemplary circuit are provided to protect the rechargeable alkaline batteries (BAT1, BAT2, BAT3, BAT4, BAT5, BAT6, BAT7, and BAT8). For example, shunt regulator components (U1, U2, U3, U4) are provided independently for each battery to limit the end-of-charge voltage to 1.65V, and to thereby prevent overcharging. Shunt regulator components (U1, U2, U3, U4) can be selected to have a low leakage current and to not be prone to temperature variations, and so that they may be suitable for preventing the battery voltage from being exceeded (e.g., are able to maintain a 1.65V maximum voltage across each cell). Transistors (Q5, Q11, Q12, Q13, Q14) switch the protection circuits on only when needed (e.g., charging voltage higher than battery voltage) in order to minimize leakage current. Hence, the control circuit of FIG. 4 includes shunt regulator circuits for protecting the batteries from being overcharged. However, the shunt regulator circuit is also configured to absorb substantially no leakage current at all times except during charging, as will be appreciated by those skilled in the art.

If the voltage of the rechargeable alkaline batteries is allowed to diminish beyond a particular threshold, the batteries will be permanently damaged. Accordingly, a circuit for an illuminated sign might incorporate components to prevent the voltage of the rechargeable alkaline batteries from being diminished below this threshold. For example, the LEDs can be selected such that their operational voltage is just above the threshold voltage of the combined battery arrangement. In such a configuration, the LEDs can simply shut off (and thereby stop consuming power) before the threshold voltage of the batteries is reached. Other alternative protection arrangements might otherwise be provided.

If the illuminated sign is constructed for use without any external power adapter, the components shown in the “Version B” area on the schematic of FIG. 4 need not be populated. If the power adapter option is provided, then the components shown in the “Version A” area on the schematic of FIG. 4 need not be populated, and the battery can be disabled when nothing is plugged into the power adapter jack (J2). Accordingly, components can be provided in the circuit to accommodate an external power adapter. Also, the schematic of FIG. 4 includes both red LEDs (D1, D2, D3, and D4) and white LEDs (D5, D6, and D7), although it should be appreciated that an exemplary illuminated sign might only include either the red LEDs (D1, D2, D3, and D4) or the white LEDs (D5, D6, and D7).

In addition to the aforementioned “storage mode”, an illuminated sign in accordance with the teachings of the present invention can have two operating modes, namely a “solar panel mode” and a “power adapter mode”. In the solar panel mode, the batteries can be charged during the day, and can then supply power to the LEDs at night. New batteries can provide up to two months operation without any charging. No power adapter is required, and the unit is self-contained and maintenance free until the batteries need replacement (e.g., typically after a few years of operation). In power adapter mode, when the power adapter is connected, the LEDs can illuminate continuously both day and night. In this configuration, the batteries and solar panel are not required to be operational or even present, although if the batteries are present, they can be continuously charged and maintained at the end-of-charge voltage so that they can provide backup during power outages (e.g., up to two months). Alternatively, in power adapter mode, an illuminated sign can be configured to turn the LEDs off during the day, in which case the solar cell serves as a photo-detector.

Methods of operating an illuminated sign should also be appreciated. For example, such a method might include the step of detecting the voltage produced by a solar cell. If that voltage is below a first threshold, LEDs can be illuminated. When the solar cell voltage exceeds the first threshold and exceeds a second threshold (e.g., the combined battery voltage), power from the solar cell can be passed to the batteries for recharging the batteries. If the solar cell voltage exceeds the first threshold but does not exceed the second threshold, then no power is passed from the solar cell to the batteries and the LEDs are not illuminated. The method might also include the step of detecting the connection of a power adapter, and might, upon such detection, continuously illuminate the LEDs. Also, the method might, in response to movement of a jumper or a switch, deactivate the circuit to substantially prevent leakage (e.g., in storage mode). It should also be appreciated that an exemplary method might incorporate any of a variety of other steps as will be appreciated by those skilled in the art upon reading the disclosure herein.

Although the illustrative illuminated signs specifically described above relate to address signs for homes and businesses, it should be appreciated that other illuminated signs in accordance with the teachings of the present invention might be provided for use in other applications. For example, an exemplary illuminated sign might be provided at a road intersection to identify a street name, at a municipal boundary to identify a city name, or for any other such application in which a geographic marker would benefit from selective illumination.

The foregoing description of exemplary embodiments and examples of the invention has been presented for purposes of illustration and description. It is not intended to be exhaustive or limit the invention to the forms described. Numerous modifications are possible in light of the above teachings. Some of those modifications have been discussed, and others will be understood by those skilled in the art. The embodiments were chosen and described in order to best illustrate the principles of the invention and various embodiments as are suited to the particular use contemplated. It is hereby intended that the scope of the invention be defined by the claims appended hereto.

1. An illuminated sign for identifying a geographic aspect, the system comprising:
a back plate;
at least one symbol configured for association with the back plate, said symbol identifying a geographic aspect;
a solar panel being supported with respect to the back plate, the solar panel comprising a solar cell, at least one rechargeable alkaline battery, an activation device, at least one LED, and a control circuit, the control circuit being electrically connected with each of the solar cell, said battery, the activation device, and said LED;
wherein the control circuit is configured to detect the presence of sunlight, is configured to facilitate selective recharging of said battery with power from the solar cell when sunlight is present, and is configured to selectively provide power to said LED from said battery when sunlight is not present so that said LED will illuminate said symbol when sunlight is not present.

2. The illuminated sign of claim 1 wherein the back plate includes a plurality of apertures, each aperture being configured to receive a screw for mounting the back plate to a wall.

3. The illuminated sign of claim 1 wherein the solar panel is supported by the back plate.

4. The illuminated sign of claim 1 wherein said symbol is associated with the back plate through use of an adhesive.

5. The illuminated sign of claim 1 wherein said symbol is configured to reflect light generated by the LED.

6. The illuminated sign of claim 1 wherein said symbol comprises at least one number.

7. The illuminated sign of claim 1 wherein the solar panel further comprises a power jack being electrically connected with the control circuit and being configured for selective connection to an external wall plug power adapter.

8. The illuminated sign of claim 1 wherein the activation device comprises at least one of a jumper and a switch.

9. The illuminated sign of claim 1 wherein the control circuit detects the presence of sunlight by monitoring voltage generated by the solar cell.

10. The illuminated sign of claim 1 wherein the control circuit includes a switch having a low voltage drop across its switched terminals as compared to the voltage drop across a standard blocking diode, the switch being configured to selectively facilitate current flow from the solar cell to said battery, the switch being further configured to interrupt said current flow when the voltage of said battery exceeds the voltage produced by the solar cell.

11. The illuminated sign of claim 10 wherein the switch comprises a transistor.

12. The illuminated sign of claim 1 wherein the control circuit includes means for selectively facilitating current flow from the solar cell to said battery.

13. The illuminated sign of claim 1 wherein the control circuit includes a shunt regulator circuit for protecting said battery from being overcharged, the shunt regulator circuit being configured to absorb substantially no leakage current at all times except during charging.

14. The illuminated sign of claim 1 wherein the control circuit further comprises shunt regulator means for protecting said battery from being overcharged.

15. The illuminated sign of claim 14 wherein the control circuit further comprises current limiting means for limiting the amount of current passed from the solar cell to said battery and to the shunt regulator means.

16. The illuminated sign of claim 1 wherein the solar panel and the back plate each comprise interconnecting fastener arrangements, whereby said fastener arrangements facilitate selective attachment of the solar panel to the back plate.

17. The illuminated sign of claim 16 whereby said fastener arrangements facilitate sliding engagement of the solar panel onto the back plate.

18. The illuminated sign of claim 1 wherein the solar panel comprises a top member and a bottom member, the top member supporting the solar cell and the bottom member supporting said LED.

19. The illuminated sign of claim 18 wherein the bottom member further supports said battery and at least part of the control circuit.

20. The illuminated sign of claim 18 wherein the bottom member is selectively removable from the top member.

21. The illuminated sign of claim 1 wherein said symbol identifies a street address corresponding to a geographic location.

22. An illuminated sign for identifying a street address of a geographic location, the system comprising:
a back plate including a plurality of apertures, each aperture being configured to receive a screw for mounting the back plate to a wall;
at least one reflective number configured for association with the back plate through use of an adhesive, said number identifying a street address corresponding to a geographic location;
a solar panel attached to the back plate, the solar panel comprising a solar cell, at least one rechargeable alkaline battery, an activation device, at least one LED, and a control circuit, the activation device comprising at least one of a jumper and a switch, the control circuit being electrically connected with each of the solar cell, said battery, the activation device, and said LED;
wherein the control circuit is configured to detect the presence of sunlight by monitoring voltage generated by the solar cell, is configured to facilitate selective recharging of said battery with power from the solar cell when sunlight is present, and is configured to selectively provide power to said LED from said battery when sunlight is not present so that said LED will illuminate said number when sunlight is not present.

23. The illuminated sign of claim 22 wherein the solar panel further comprises a power jack being electrically connected with the control circuit and being configured for selective connection to an external wall plug power adapter.

24. The illuminated sign of claim 22 wherein the control circuit includes a switch having a low voltage drop across its switched terminals as compared to the voltage drop across a standard blocking diode, the switch being configured to selectively facilitate current flow from the solar cell to said battery, the switch being further configured to interrupt said current flow when the voltage of said battery exceeds the voltage produced by the solar cell.

25. The illuminated sign of claim 22 wherein the control circuit includes a shunt regulator circuit for protecting said battery from being overcharged, the shunt regulator circuit being configured to absorb substantially no leakage current at all times except during charging.

26. An illuminated sign for identifying a street address of a geographic location, the system comprising:
a back plate including a plurality of apertures, each aperture being configured to receive a screw for mounting the back plate to a wall;
at least one number configured for association with the back plate, said number identifying a street address corresponding to a geographic location;
a solar panel attached to the back plate, the solar panel comprising a solar cell, at least one rechargeable battery, an activation device, at least one LED, and a control circuit, the control circuit being electrically connected with each of the solar cell, said battery, the activation device, and said LED, the control circuit including a switch having a low voltage drop across its switched terminals as compared to the voltage drop across a standard blocking diode, the switch being configured to selectively facilitate current flow from the solar cell to said battery, the switch being further configured to interrupt said current flow when the voltage of said battery exceeds the voltage produced by the solar cell;
wherein the control circuit is configured to detect the presence of sunlight by monitoring voltage generated by the solar cell, is configured to facilitate selective recharging of said battery with power from the solar cell when sunlight is present, and is configured to selectively provide power to said LED from said battery when sunlight is not present so that said LED will illuminate said number when sunlight is not present.
